(19) United States
(12) Patent Application Publication
(10) Pub. No.: US 2026/0266318 A1
(43) Pub. Date: Sep. 10, 2026

(54) Connecting Device with a Bridge Section for a Second Base Body of a Second Connecting Part

(71) Applicant: Fidlock GmbH, Hannover (DE)

(72) Inventors: Timon Oliver Pankoke, Hannover (DE); Artur Siebert, Hannover (DE); Joachim Fiedler, Hannover (DE)

(21) Appl. No.: 18/876,208

(22) PCT Filed: Apr. 9, 2024
(86) PCT No.: PCT/EP2024/059593

§ 371 Date: Dec. 18, 2024

(30) Foreign Application Priority Data
Apr. 17, 2023 (DE) 10 2023 109 584.6

(51) Int. Cl. F16B 1/00; A44B 11/25; A45C 13/10

(52) U.S. Cl. CPC F16B 1/00; A44B 11/258; A45C 13/1069; A44D 2203/00; F16B 2200/83

(57) ABSTRACT

A connecting device, including a first connecting part which includes a first base body and an engagement device with at least one engagement protrusion, and a second connecting part which can be attached to the first connecting part, which includes a second base body with at least one engagement portion arranged on the second base body, wherein the at least one engagement portion can be brought into engagement with the engagement device of the first connecting part, so that the first connecting part and the second connecting part are held against one another in a connected position.

### CROSS-REFERENCE TO RELATED APPLICATIONS

This application is the United States national phase of International Patent Application No. PCT/EP2024/059593, filed on Apr. 9, 2024, and claims priority to German Patent Application No. 10 2023 109 584.6, filed on Apr. 17, 2023, the disclosures of which are hereby incorporated by reference in their entireties.

### BACKGROUND

### Technical Field

The proposed solution relates to a connecting device.

### Technical Considerations

In a fastening device known from EP 3 616 553 A1 for detachably connecting two parts, a first connecting part can be attached to a second connecting part in order to connect the connecting parts to one another. A shoelace is arranged on one of the connecting parts, which can be tightened by connecting the connecting parts to one another.

A fastening device is known from EP 3 192 388 B1, in which a first connecting part comprises a rigid engagement protrusion and can be connected to a second connecting part. A strap is adjustably arranged on the second connecting part.

### SUMMARY

The object underlying the proposed solution is that of providing a connecting device that enables subassemblies to be connected to each other easily and reliably.

This object is achieved by a connecting device having features as described herein.

A non-limiting embodiment of a connecting device according to the present disclosure comprises, inter alia, a first connecting part which is associated with a first subassembly and comprises a first base body and an engagement device with at least one engagement protrusion, and a second connecting part which is associated with a second subassembly, can be attached to the first connecting part and comprises a second base body with at least one engagement portion arranged on the second base body. The at least one engagement portion can be brought into engagement with the engagement device of the first connecting part, so that in a connected position (of the first and second connecting parts) the first connecting part and the second connecting part are held together. The first connecting part and the second connecting part each comprise a magnetic device, which interact in a magnetically attracting manner to support the attachment of the first connecting part and the second connecting part. In order to be able to manually or mechanically attach the second connecting part to the first connecting part and detach it from the second connecting part in the connected position, the second connecting part is connected to a handling portion. The second connecting part can be attached to the first connecting part via the handling portion. Furthermore, in the connected position of the first and second connecting parts, an (opening) force can be applied to the handling portion in order to disengage the engagement portion from the engagement device and release the second connecting part from the first connecting part.

In connection devices known on the market to date, the handling portion is typically connected to a base portion, or merges into such a base portion on which the second base body of the second connection part is provided. A displacement of the handling portion is thus accompanied by a direct displacement of the second base body, whereby the connection to the second subassembly is typically also established via the base portion or the base portion is part of the second subassembly. The handling portion is therefore intended to place the second connecting part against the first connecting part and, in the connected position of the first and second connecting parts, to apply a force thereto in order to disengage the engagement portion from the engagement device.

For example, by pulling on the handling portion, the second connecting part with the second base body and a portion of the second subassembly connected thereto can then be brought closer to the first base body of the first connecting part and the two connecting parts can be brought into engagement with one another in order to connect the two subassemblies to one another via the connecting device. For example, a tensile force is introduced via the handling portion in order to bring a strap carrying the second connecting part, a flap or flap carrying the second connecting part or a comparable portion of a second subassembly closer to the first connecting part and to secure it thereto. If a comparatively high tensile force has to be applied here, for example because a container or item of clothing whose two subassemblies are to be held together is heavily filled or widened and the second connecting part therefore has to be attached to the first connecting part against a clamping force, it may be more difficult for the engagement portion to engage with the engagement device. It may also be more difficult to release the second connecting part from the first connecting part in such a situation due to the load acting on the connecting device, particularly if a clamping force counteracting the release of the connection acts not only directly on the handling portion, but also on the second base body of the second connecting part. Furthermore, in the connected position of the first and second connecting parts, when the second base body is arranged on the base portion connected to the second subassembly, a load acting on the base portion via the second subassembly acts directly on the second base body and thus on the connection of the first and second connecting parts.

Against this background, for transmitting the force to the second connecting member to disengage the engagement portion with the engagement device and disengage the second connecting member from the first connecting member, a transmission part is provided on the connecting device, comprising the handling portion, a base portion connected to the handling portion and extending along an extending direction, and a bridge portion connected to the base portion at a first end point. The bridge portion extends between the first end point and a second end point spaced apart from the first end point in the extension direction with a length that is greater than the distance between the two end points. The second base body is held on this bridge portion, whereby the bridge portion can then be displaced with the second base body relative to the base portion and the handling portion when the second connecting part is attached to the first connecting part.

Due to the displaceability of the bridge portion and the second base body provided thereon, for example, the at least one engagement portion of the second base body can be brought into engagement with the engagement device of the first base body more easily with magnetic support, since a displacement movement of the second base body relative to the base portion and the handling portion is permitted for this purpose. Even under tension on the handling portion and the base portion, the second base body can thus be displaced in a targeted manner, for example to allow it to snap onto the first base body with magnetic support.

When the first and second connecting parts are connected, a force can again be introduced via the handling portion in order to disengage the engagement portion from the engagement device and release the second connecting part from the first connecting part. Here, for example, a force introduced at the handling portion can be transmitted via the base portion into the bridge portion and via this in turn to the second base body.

In non-limiting embodiments, a defined play of the second base body relative to the handling portion is provided via the bridge portion. The second base body can therefore be displaced by a predetermined amount relative to the handling portion. In this way, the second base body can be displaced independently of and relative to the handling portion within limits defined by the bridge portion when the second connecting part is attached to the first connecting part. Furthermore, in the connected position of the first and second connecting parts, the base portion can be displaced via the bridge portion to the second base body in the event of a load acting on the base portion (e.g., from the second subassembly to the base portion). As a result, in the connected position, not every load acting on the second subassembly and the base portion connected to it is transferred directly to the second base body. In the connected position, a certain degree of decoupling of the base portion and the second base body is therefore achieved via the bridge portion.

The bridge portion can also be used to limit the rotatability of the second base body with respect to the handling portion. If the second base body is provided on a bridge portion that extends between the two end points and can be displaced, it is comparatively easy to limit the rotatability of the second base body with respect to the handling portion, for example by means of the length of the bridge portion and/or its rigidity.

In principle, the length bridged by the bridge portion between the first end point and the second end point is less than the total length of the bridge portion between the first end point and the second end point. The second end point can also be provided at the base portion so that the bridge portion extends between two areas of the base portion. However, this is by no means mandatory. For example, a second end point can also be provided on a component of the second subassembly connected to the base portion.

In principle, a tensile force introduced at the handling portion and acting along a tensile direction can be transmitted via the base portion to attach the second connecting part to the first connecting part. In this case, the bridge portion can be displaced relative to the base portion along a connecting direction that is inclined to the tensile direction, in particular running perpendicularly, in order to bring the engagement portion into engagement with the engagement device. Thus, a comparatively large tensile force can be applied along the tensile direction (in particular manually) in order to bring the first and second connecting parts sufficiently close together so that-supported by the magnetic interaction of the first and second magnetic devices-the engagement portion can come into engagement with the engagement device and the first and second connecting parts can be transferred into the connected position. By allowing the second base body with the bridge portion to be displaced relative to the base portion loaded with the tensile force, the second base body can be brought closer to the first base body up to a predetermined minimum distance in order to achieve this engagement and an associated snapping of the second base body onto the first base body without the corresponding tensile force acting on the second base body itself.

The bridge portion is made, for example, from a flexible material or is configured to be elastically displaceable. The manufacture of the bridge portion from a flexible material includes, for example, that the bridge portion consists of a flexible material portion, for example a flexible, in particular textile material portion, a leather material portion or a plastic surface portion.

In non-limiting embodiments, the bridge portion can be made up of several fixed and/or flexible elements. In this case, the bridge portion can be displaced relative to one another by adjusting the fixed and/or flexible elements. In this context, for example, it may be provided that the bridge portion comprises a multi-link chain, in particular is formed by a multi-link chain.

The second base body can be fixed to the bridge portion. This includes in particular that the second base body is sewn to a flexible material of the bridge portion.

In non-limiting embodiments, the second base body comprises a connection portion which is at least partially embraced, in particular gripped behind, by a bridge portion consisting of a flexible material and/or constructed in multiple members. In this case, the second base body is therefore not directly fixed rigidly to the bridge portion. Rather, partial gripping of the bridge portion ensures that the second base body is held on the bridge portion and can be displaced relative to the handling portion. A force can nevertheless be transmitted from the bridge portion at the connection portion to the second base body via the partial grip of the second base body by the flexible and/or multi-link bridge portion in order to disengage the engagement portion from the engagement device and to displace the second base body relative to the first base body for this purpose.

In principle, it can be provided that in the connected position of the first and second connecting parts, the second base body can be tilted with respect to the first base body in order to disengage the engagement portion from the engagement device. Consequently, the first and second connecting parts are configured here such that the second base body must perform a pivoting movement with respect to the first base body in order to disengage the engagement portion from the engagement device. Accordingly, the transmission part, which in particular has the bridge portion, is intended to transmit a force to the second connecting part in the connected position, which leads to a pivoting movement of the second base body with respect to the first base body. Consequently, the second base body can be tilted here relative to the first base body in order to enable the at least one engagement portion and the at least one engagement protrusion to be brought out of engagement in order to separate the first connection part and the second connection part from one another. In this context, it may be provided, for example, that the second base body can be lifted away from the first base body for tilting relative to the first base body on a side (of the second base body) facing away from the at least one engagement protrusion.

Conversely, a tilting movement of the second base body relative to the base portion and handling portion can be permitted for assuming the connected position and engagement of the engagement portion with the engagement device when the second connecting part is attached to the first connecting part via the bridge portion.

In non-limiting embodiments, the first connecting part can additionally comprise a blocking portion arranged rigidly on the first base body, which is configured to interact with the second connecting part in the connected position in order to block the engagement of the at least one engagement portion with the at least one engagement protrusion in the opposite direction to the engagement direction. When the connecting parts are attached, the at least one engagement portion of the second connecting part comes into engagement with the at least one engagement protrusion of the first connecting part in the engagement direction, so that in the connected position there is a form-fit or force-fit connection between the connecting parts and the connecting parts are thus held together in a resilient manner by the engagement of the at least one engagement portion with the at least one engagement protrusion. The engagement between the at least one engagement portion of the second connecting part and the at least one engagement protrusion of the first connecting part is secured in the connected position by the blocking portion of the first connecting part, which is rigidly formed on the first base body of the first connecting part, in that the blocking portion interacts with an associated portion of the second connecting part in a blocking manner counter to the engagement direction and the at least one engagement portion can therefore not be moved counter to the engagement direction towards the at least one engagement protrusion, at least not without the blocking being released. Due to the blocking effect of the blocking portion, the at least one engagement portion is thus blocked in its engagement with the at least one engagement protrusion.

In non-limiting embodiments with a blocking portion, the connecting parts could be held relative to each other in the connected position due to the magnetic effect of the magnetic devices in such a way that the connecting parts are blocked relative to each other by the blocking portion of the first connecting part against the engagement direction. The connecting parts can therefore not be released from each other by a (pure) sliding movement against the engagement direction.

In non-limiting embodiments, the second connecting part can, as explained above, be tiltable relative to the first connecting part for releasing the connecting parts from each other. In non-limiting embodiments with a blocking portion, the second connecting part can then be tilted relative to the first connecting part for releasing the connecting parts from one another, in order to move the second connecting part in a tilting plane spanned by the closing direction and the engagement direction relative to the first connecting part in such a way that the second connecting part can be moved against the engagement direction to the blocking portion on the first base body. By tilting the second connecting part relative to the first connecting part, the blocking effect of the blocking portion can be canceled, so that the second connecting part can be moved over the blocking portion and thus the at least one engagement portion of the second connecting part can be disengaged from the at least one engagement protrusion of the first connecting part.

The blocking effect of a blocking portion arranged rigidly on the first base body of the first connecting part allows the second connecting part not to be moved linearly against the engagement direction, but to be tilted in a tilting plane spanned by the closing direction and the engagement direction in order to separate the connecting parts from each other. The tilting movement can take place around a defined tilting axis. However, the tilting movement can also take place along a curved path of movement located in the tilting plane, whereby the second connecting part is tilted relative to the first connecting part as a result of the tilting movement. The tilting movement can be superimposed by a rectilinear movement against the engagement direction and/or against the closing direction.

It should be noted that the connecting parts can be tilted towards each other to separate the connecting parts. The connection between the connecting parts is also established, for example, not in a straight closing movement, but by the connecting parts wobbling against each other while tilting and moving into engagement with each other. When establishing the connection, the second connecting part can also tilt towards the first connecting part in order to enable the engagement of the at least one engagement portion of the second connecting part with the at least one engagement protrusion of the first connecting part.

In the connected position, the second connecting part can be rotated about the closing direction relative to the first connecting part in non-limiting embodiments. On the one hand, this can enable the connecting parts to be attached to each other with angular tolerance. In addition, this makes it possible to rotate the second connecting part relative to the first connecting part when the connecting parts are in the connected position. When twisting or rotating, the at least one engagement portion and the at least one engagement protrusion retain their engagement. In addition, the blocking of the engagement by the blocking portion also remains in place during rotation. Rotating the connecting parts around the closing direction in relation to one another in the connected position therefore does not lead to the connecting parts separating from one another.

Rotatability between the connecting parts in the connected position can enable any rotational movement through any angle. However, it is also conceivable that the movement of the connecting parts is limited to a predetermined rotary angle, for example by stops or the like. The rotary angle is preferably greater than 10°, more preferably greater than 20°, particularly preferably greater than 45° or even greater than 90°.

Nevertheless, not necessarily, the at least one engagement protrusion can be provided rigidly and non-deformably (with a load acting as intended) on the first base body of the first connecting part. If the at least one engagement protrusion is formed rigidly and non-deformably (with a load acting as intended) on the first base body of the first connecting part, the engagement protrusion may be able to absorb and dissipate forces more reliably when engaging with the at least one engagement portion of the second base body. The at least one engagement protrusion can be formed in one piece with the first base body of the first connecting part, wherein the first base body is rigid and non-deformable overall.

Alternatively, or additionally, the engagement portion can be rigidly provided on the second base body. This includes in particular that the engagement portion is rigidly formed on the second base body. For example, the second base body of the second connecting part with the at least one engagement portion formed thereon is rigid and non-deformable and is made of metal or a hard plastic material, for example.

In this context, “non-deformable” should be understood to mean an essentially rigid geometry and choice of material of the base body, which ensures that the base body of the first connecting part with the engagement protrusion formed thereon does not deform under the intended load, i.e., the base body is not elastic. For example, the base body of the first connecting part can be made of metal or a hard plastic material.

In non-limiting embodiments, the second connecting part, as explained above, can be lifted away from the first connecting part on a side facing away from the at least one engagement protrusion, counter to the closing direction, for tilting relative to the first connecting part. In the connected position, the second connecting part can also engage with the at least one engagement protrusion on the first base body of the first connecting part via the at least one engagement portion provided on the second base body, this engagement taking place in a front region of the second connecting part as seen with respect to the engagement direction. With a rear region in relation to the engagement direction, the second connecting part can be lifted away from the first connecting part in the connected position against the closing direction in order to tilt the second connecting part relative to the first connecting part in this way. If a blocking portion is provided, the second connecting part can be lifted from the first connecting part in the connected position against the closing direction in order to tilt the second connecting part relative to the first connecting part in this way and thereby cancel the blocking effect of the blocking portion of the first connecting part, so that the second connecting part can be moved towards the blocking portion of the first connecting part and the at least one engaging portion can be disengaged from the at least one engaging protrusion against the engagement direction.

For example, the at least one engagement portion of the second connecting part is formed by an edge portion which can be brought into engagement with the at least one engagement protrusion. Alternatively, or additionally, the at least one engagement portion of the second connecting part can extend around the circumference of the first base body. In this case, the second connecting part can in particular comprise a single engagement portion that extends circumferentially on the second base body and thereby projects (radially) outwards. The engagement portion is undercut in that a further portion adjoining the engagement portion recedes inwards relative to the engagement portion and thus enables the engagement portion to be brought into engagement with the at least one engagement protrusion of the engagement device of the first connecting part.

If the second base body of the second connecting part is rotationally symmetrical on a pin forming the engagement portion, the engagement portion projects radially outwards and extends around the pin in a circle.

However, the second base body can also be non-rotationally symmetrical. In this case, the engagement portion can, for example, be angular, e.g., quadrangular, on the base body.

The first subassembly and/or the second subassembly may be made, for example, by a flexible fabric portion, for example, of a textile fabric, a leather fabric, a plastic surface portion and another material. The first subassembly and/or the second subassembly may, for example, be formed by a belt, by a strap, by a part of a garment, by a part of a bag, a backpack or another container or by a completely different subassembly. Such a portion of fabric can have completely different fabric thicknesses, whereby the fabric can be perforated for attaching the connecting device in the case of greater fabric thicknesses or a harder material.

However, the first subassembly and/or the second subassembly can also be formed by a solid object, for example a plastic part.

In the connecting device, for example, one or both of the connecting parts can be connected to the respective associated subassembly via a seam connection, although other types of connection between a subassembly and an associated connecting part are also possible. To create a seam connection, a sewing thread can be passed through a sewing area on the respective base body in order to create a seam between the respective connecting part and the associated subassembly and thus connect the connecting part to the subassembly.

The connecting parts can be attached to each other to connect the subassemblies and are arranged in a connected position in such a way that they are held together by magnetic interaction of the magnetic devices and also by the engagement of the engagement portion of the second connecting part with the engagement device of the first connecting part. In the operational state, the connecting parts are connected to the respective subassembly. To close the connecting device, the connecting parts are placed against each other with magnetic support by a magnetic attraction force of the magnetic devices, so that the at least one engagement portion of the second connecting part comes into engagement with the at least one engagement protrusion of the engagement device of the first connecting part and a connection is thus produced between the connecting parts.

To close the connecting device, the connecting parts can be attached to each other along a closing direction, for example. Along the closing direction, the magnetic devices interact in a magnetically attracting manner so that the connecting parts are drawn towards each other with magnetic support. However, it is also possible to attach the connecting parts along a direction other than the closing direction.

The connection between the connecting parts in the connected position can be free of play or may have play.

The engagement of the at least one engagement portion with the at least one engagement protrusion in the connected position can be form-fitting or force-fitting. In particular, the at least one engagement portion and/or the at least one engagement protrusion can have surfaces extending perpendicular to a closing direction or surfaces extending at an angle to the closing direction, which in the connected position point towards one another and produce a positive or positive-locking, backlash-free or backlash-prone connection.

The connecting parts can be held in the connected position along the closing direction and/or along a direction that is transverse or oblique to the closing direction.

For example, a load direction along which, for example, belt forces act can be directed transversely or at an angle to the closing direction. However, a load direction can also act against the closing direction, for example.

Attachment of the connecting parts to each other is supported magnetically. For this purpose, the first connecting part has a first magnetic device and the second connecting part has a second magnetic device. In particular, the first magnetic device and the second magnetic device support the attachment of the connecting parts to each other. The magnetic devices have a magnetically attracting effect along a closing direction, for example, so that the magnetic devices cause a magnetic attracting force along the closing direction and pull the connecting parts towards each other along the closing direction when they are attached.

The magnetic devices can, for example, each be formed by a permanent magnet. However, it is also possible to configure one of the magnetic devices with a permanent magnet and the other of the magnetic devices with a magnetic armature and thus with a passive magnetic (ferromagnetic) element.

In non-limiting embodiments, the at least one engagement portion is formed by an edge portion which can be brought into engagement with the at least one engagement protrusion. The at least one engagement portion may be formed by an outwardly facing edge portion extending around the second base body. In non-limiting embodiments, the at least one engagement portion may not be formed circumferentially on the base body, but only on one end face, for example. In this case, the edge portion can delimit the second base body outwards when viewed along the second plane.

The fact that the at least one engagement portion can be brought into engagement with the at least one engagement protrusion parallel to a second plane along which the engagement portion extends on the base body, or along a direction extending obliquely thereto, means that the at least one engagement portion and the at least one engagement protrusion, viewed along a direction perpendicular to this second plane, at least partially coincide with one another. The engagement thereby (also) produces a hold along the direction perpendicular to the second plane between the connecting parts.

In non-limiting embodiments, the at least one engagement portion of the second connecting part, viewed along a second plane, projects outwards relative to a further portion of the second base body. The second plane can, for example, be directed approximately perpendicular to a closing direction along which the connecting parts can be attached to one another to close the connecting device (whereby it is not excluded that the connecting parts can also be attached to one another in a direction deviating from the closing direction). Transverse to the closing direction, the at least one engagement portion protrudes from a further portion of the second base body of the second connecting part. The at least one engagement portion is thus undercut with respect to a direction perpendicular to the second plane, in that the further portion springs back relative to the engagement portion and thus enables engagement with the at least one engagement protrusion of the engagement device of the first connecting part.

Surfaces of the engagement portion on the one hand and of the at least one engagement protrusion on the other hand, which face each other in the connected position and engage with each other without play or with play, can be aligned along a second plane, along which the engagement portion extends on the base body, or at an angle to the second plane in order to produce a form-fit or force-fit connection.

The connection can be established solely via the at least one engagement portion and the at least one engagement protrusion. However, it is also conceivable that other connecting partners may also be involved in establishing the connection.

In non-limiting embodiments, the second base body has two engagement portions formed on edges pointing away from each other. Thus, (at least) two engagement portions are formed on the base body, which are formed on different edges of the base body. The engagement portions are each undercut in that the engagement portions project outwards and a further portion of the base body adjoining the respective engagement portion projects back in such a way that the respective engagement portion can be brought into engagement with an associated engagement protrusion of the engagement device of the first connecting part in order to close the connecting device.

In non-limiting embodiments, the at least one engagement protrusion of the first connecting part is rigidly formed on the first base body. The at least one engagement portion of the second connecting part can be brought into engagement with the at least one engagement protrusion of the first connecting part, for example along an engagement direction which is parallel or oblique to a first plane along which the at least one engagement protrusion extends. The at least one engagement protrusion of the first connecting part is thus rigidly and non-elastically formed on the first base body of the first connecting part.

To close the connecting device, the at least one engaging protrusion can be brought into engagement with the at least one engagement portion rigidly formed on the second base body of the second connecting part, preferably by pushing the at least one engagement portion into engagement with the at least one engaging protrusion in an engagement direction parallel or oblique to the first plane. In the connected position, the at least one engagement portion is thus engaged (without play or with play) with the at least one engagement protrusion, so that the connecting parts are held in position relative to one another along a direction perpendicular or oblique to the first plane via the engagement of the at least one engagement portion with the engagement protrusion. Surfaces of the at least one engagement portion and the at least one engagement protrusion facing one another can be aligned along the first plane or at an angle to the first plane.

Thus, in non-limiting embodiments of the connecting device, one or more engagement protrusions are rigidly formed on the first base body of the first connecting part. The second connecting part can be brought into engagement with the at least one engagement protrusion by bringing the at least one engagement portion of the second connecting part into engagement with the at least one engagement protrusion of the first connecting part. The first connecting part and the second connecting part are attached to one another, for example, along a closing direction along which magnetic devices of the connecting parts provide a magnetic attraction force so that the connecting parts are drawn towards one another along the closing direction. In contrast, the engagement of the at least one engagement portion of the second connecting part with the at least one engagement protrusion of the first connecting part takes place along an engagement direction that is transverse or oblique to the closing direction. In the connected position, the at least one engagement portion engages with the at least one engagement protrusion in a form-fit or force-fit manner, so that the connecting parts are held together.

In non-limiting embodiments, the first connecting part comprises two engagement protrusions that are spaced apart transversely to the closing direction and transversely to the engagement direction.

The at least one engagement portion can have a curved (arcuate) shape. In this case, the at least one engagement portion can be formed circumferentially on the second base body or, alternatively, can be formed on the second base body only over an arcuate portion, for example over an arcuate portion of less than 180°. If the engagement portion extends around the second base body, the engagement portion can be formed in a circular shape or also have another shape, for example an angular shape, for example a polygonal shape, for example a quadrangular or hexagonal shape.

Irrespective of the specific configuration of the first connecting part and the second connecting part, in particular the at least one engagement protrusion of the engagement device of the first connecting part and the at least one engagement portion of the second connecting part, the connecting parts can be configured in such a way that the second connecting part can be rotated in the connected position about a direction perpendicular to the first plane relative to the first connecting part. In the connected position, the connecting parts can thus be rotated relative to one another.

Other configurations of the connecting parts are also conceivable and possible, whereby the at least one engagement protrusion can be arranged rigidly or movably relative to the first base body of the first connecting part and/or whereby the at least one engagement portion can be arranged rigidly or movably relative to the second base body of the second connecting part.

In principle, the first connecting part and/or the second connecting part can have a multi-part configuration. This includes, in particular, that the first connecting part and/or the second connecting part comprise at least two elements hingedly connected to one another.

The proposed solution also relates to a system, which comprises a first subassembly and a second subassembly, wherein the first and second subassemblies can be connected with a non-limiting embodiment of a connecting device according to the present disclosure. The subassemblies can in turn be part of a higher-level subassembly or be connected to each other via further elements in an overall system. In a proposed system, the base portion of the transmission part to which the handling portion is connected can be connected to the second subassembly or can be formed at least partially or completely by a portion of the second subassembly.

Non-limiting embodiments of the connecting device according to the present disclosure can, for example, be part of a bag or backpack or protective clothing, such as a protective vest. In this context, for example, a first subassembly can be formed by a bag or rucksack body and a second subassembly by a bag lid or a rucksack flap.

The possible uses listed below are intended to illustrate the diverse usability of the connecting device, but are not intended to be limiting and, in particular, are not intended to be exhaustive. For example, the connecting device can be used, in particular as a closure, for:
bags,
helmets,
horse halter,
removable (chest) pouch,
bags, rucksacks,
for bags with roll top, for closing with (elastic) webbing,
jacket fasteners (e.g., on sleeves, lapels, button placket, or tying up shirt sleeves),
roller blinds in motorhomes or privacy screens on or in a caravan,
covers,
awnings, tarpaulins, camping tents, tent guy ropes,
fastening or locking panniers or saddlebags (bicycle, motorcycle),
luggage and load securing, or securing bicycles/prams in and on public transport vehicles,
strap fasteners, restraint systems and fastening devices for carrying equipment,
chest straps, hip straps, shoulder straps,
protective equipment or protective clothing, especially vests (e.g., ballistic vests),
detachable handles or carrying straps on bags,
folding sunshade, e.g., for baby carriages,
movable and removable or openable connection of backpack carrying straps,
furniture, for example for attaching textile elements,
sleeping bags, sleeping mats, yoga mats (for rolling up and fastening),
towel rails,
key holders,
belts,
craftsman belts,
detachable carrying straps, e.g., on tools and garden equipment, handles on bags and electrical appliances,
gloves, shoes, items of clothing (also for fastening or attaching to other objects or items of clothing),
golf bags,
nets on baby carriages, tents or other elements.

### BRIEF DESCRIPTION OF THE DRAWINGS

The attached figures illustrate examples of exemplary and non-limiting embodiments of the present disclosure.

FIG. 1A is a perspective view of a front side of a backpack with non-limiting embodiments of a connecting device according to the present disclosure for closing a flap on the top of the backpack;

FIG. 1B shows the backpack with a flap, which is no longer shown, to which a second connecting part of the connecting device is attached;

FIG. 1C shows the backpack of FIG. 1B showing further details of the connecting device;

FIG. 2 is an enlarged view of the second connecting part of the connecting device for the backpack of FIGS. 1A to 1C;

FIG. 3 is an enlarged view of the connecting device in a connected state of a first connecting part and the second connecting part during a first phase of separating the first and second connecting parts from each other;

FIG. 4 is an enlarged and individual view of the first connecting part of the connecting device;

FIG. 5A shows in a first phase, the attachment of the second connecting part to the first connecting part in order to connect the first and second connecting parts to one another;

FIG. 5B is in a view corresponding to FIG. 5A, a subsequent second phase of connecting the first and second connecting parts to each other, in which a second base body of the second connecting part is already engaged with a first base body of the first connecting part;

FIG. 6 is a perspective view of a second connecting part of a non-limiting embodiment of a connecting device according to the present disclosure, in which a second base body of the second connecting part is hinged to a coupling element of the second connecting part;

FIG. 7 is a perspective view of a first connecting part for the connection with the second connecting part of FIG. 6;

FIG. 8A shows the connecting device with the first and second connecting parts of FIGS. 6 to 8 in an unconnected state in a first phase of attaching the second connecting part to the first connecting part;

FIG. 8B is in a view identical to FIG. 8A, a second phase of the attachment, in which the second base body of the second connecting part is already engaged with the first base body of the first connecting part;

FIG. 9 shows the first and second connecting parts of FIGS. 6 and 7 in a connected position; and

FIG. 10 shows the connecting device of FIGS. 6 to 9B in a first phase of separating the second connecting part from the first connecting part.

### DETAILED DESCRIPTION

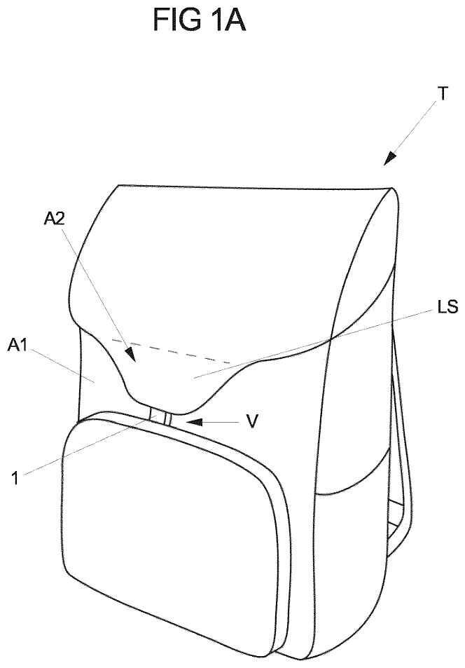

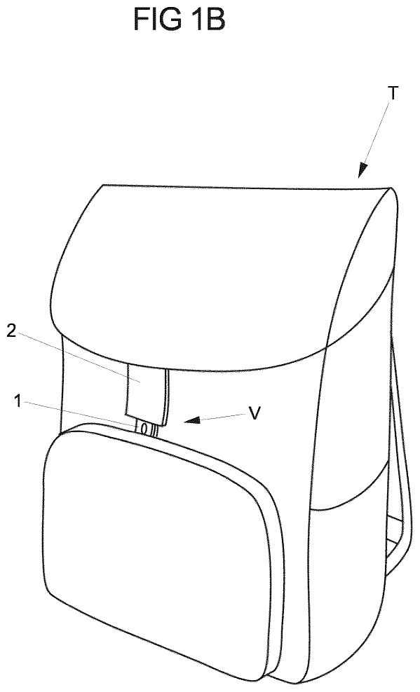

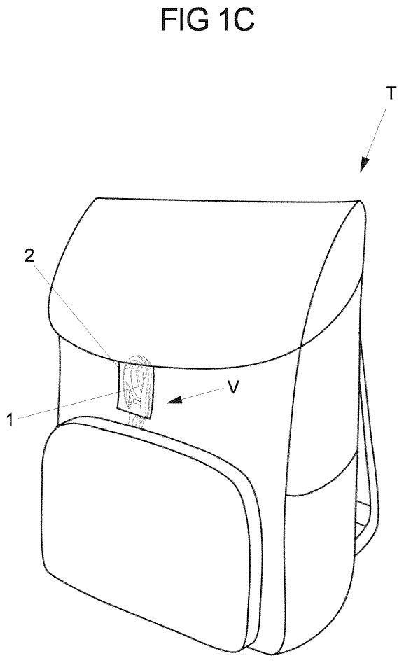

FIGS. 1A, 1B and 1C show the use of a non-limiting embodiment of a connecting device according to the present disclosure V on a backpack T in order to detachably connect a second subassembly A2 to a first subassembly A1. The second subassembly A2 is a flap on the top of the backpack T. This flap is to be connected to the first subassembly A1 on the front of the backpack T via a tab LS in order to close an opening on the top of the backpack T, via which the inside of the backpack T is accessible when the flap is open. A second connecting part 2 of the connecting device V is provided on the underside of the flap LS for this purpose. This second connecting part 2 can be connected to a first connecting part 1 of the connecting device V on the front of the backpack T. For example, the connecting parts 1 and 2 of the connecting device V are fixed to a component of the respective subassembly A1 or A2 by sewing.

FIG. 1B shows the backpack T with the flap LS, which is no longer shown here, in order to illustrate the connecting device V in a connected state. FIG. 1C also shows details of the first connecting part 1 concealed by the second connecting part 2.

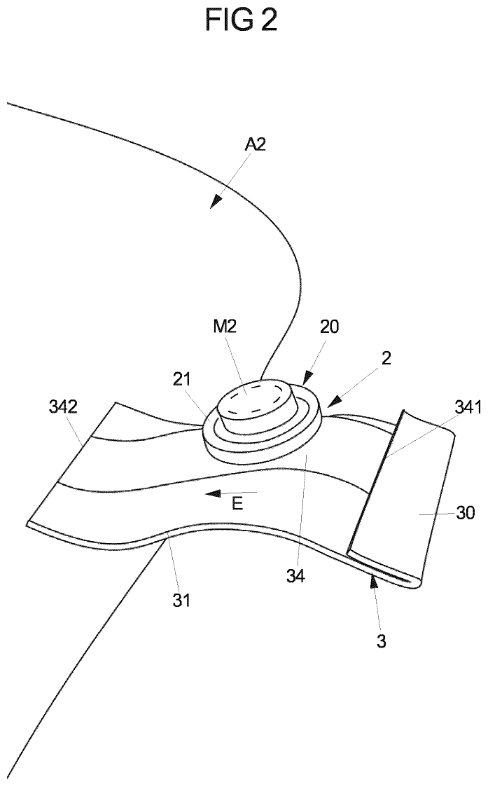

FIG. 2 shows an enlarged view of the second connecting part 2 provided on an underside of the flap LS. The second connecting part 2 comprises, inter alia, a rigid base body 20 which is to be brought into positive engagement with a first base body 10 of the first connecting part 1 of the connecting device V via a circumferentially formed engagement portion 21. A second magnetic device M2 is provided in a pin projecting from the second base body 20, around which the engagement portion 21 extends as a circumferential edge. When the second connecting part 2 is attached to the first connecting part 1, this second magnetic device 2 interacts with a first magnetic device M1 of the first connecting part in a magnetically attracting manner in order to support the positive engagement of the engagement portion 21 of the second connecting part 2 in the first base body 10 of the first connecting part 1 and to achieve automatic assumption of the connected position of the first and second connecting parts 1 and 2 when the two base bodies 10 and 20 are sufficiently close to each other. In the connected position, the first and second connecting parts 1 and 2 are held together and cannot be rotated relative to one another.

In the second connecting part 2 shown in FIG. 2, a transfer part 3 with a handling portion in the form of a grip tab 30 is provided in order to apply a force to attach the first connecting part 2 to the first connecting part 1 and, when the first and second connecting parts 1 and 2 are connected, to apply a force to release the two connecting parts 1 and 2 from each other. The grip tab 30 provided in the present case for manual engagement is made of a flexible material and merges into a longitudinally extended, likewise flexible base portion 31, via which the transmission part 3 is connected to the second subassembly A2 and possibly the tab LS of the backpack T. Accordingly, by pulling on the grip tab 30, manual action can be exerted on the tab LS of the backpack T in order to close or open the flap on the top of the backpack T and, accordingly, to secure the second connecting part 2 to the first connecting part 1 or to separate it therefrom. The base portion 31, the grip tab 30 and the bridge portion 34 are formed, for example, by a continuous textile strap or leather strap, in which two opposing portions are fixed to one another at least at the first end point 341.

In order to support a simple and therefore easily accessible engagement of the second base body 20 with its engagement portion 21 on the first base body 10, in particular when closing the connecting device V and a tension acting on the base portion 31 (in particular when the backpack T is filled to capacity), the second base body 20 of the second connecting part 2 is not provided directly on the base portion 31 in the present case. Rather, the second base body 20 is arranged in the present case on a bridge portion 34, for example fixed thereto by sewing, which allows the base body 20 to be displaced with respect to the base portion 31 and the grip tab 30. Thus, in the present case, the bridge portion 34 extends from a first end point 341 on the base portion 31 in the region of the grip tab 30 to a second end point 342 in the region of the end of the base portion 31, at which the base portion 31 is connected to the second subassembly A2 or merges into it. The bridge portion 34 is thus fixed at the end points 341 and 342. The length of the bridge portion 34 between these end points 341, 342 is greater than a distance between the two end points 341 and 342, measured along an extension direction E of the base portion 31, which points from the bridge portion 30 to a force introduction point at which the base portion 31 transmits a force into the second subassembly A2 or, conversely, a force acting on the second subassembly A2 is introduced into the base portion 31. In the present case, the bridge portion 34 is also made of a flexible material and bridges the two end points 341 and 342, so that the bridge portion 34 can be displaced transversely to the extension direction E relative to the base portion 31.

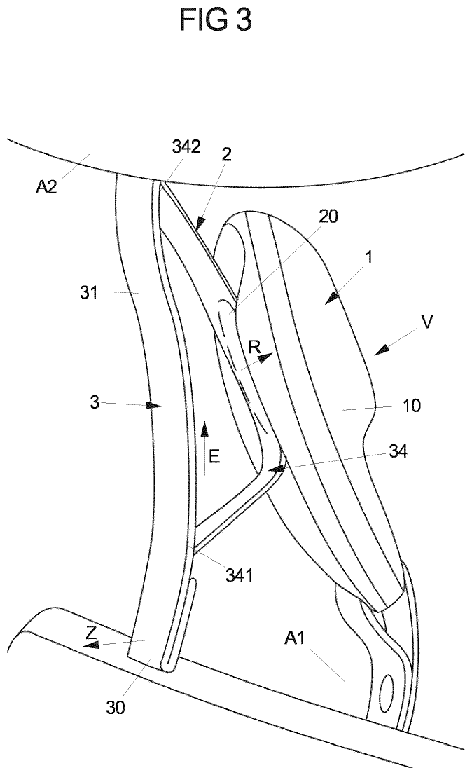

As illustrated in particular with reference to FIG. 3, in the connected state of the first and second connecting parts 1 and 2, a displacement movement of the base portion 31 as a result of a force (manually) applied to the handle tab 30 does not lead to an immediate displacement of the second base body 20 due to the presence of the second base body 20 on the bridge portion 34. Rather, the grip tab 30 with the base portion 31 connected thereto can initially be displaced by a defined adjustment path along a tensile direction Z when a pulling force is applied to open the upper flap on the backpack T, without a force acting directly on the second base body 20. In addition, the bridge portion 34 ensures that in the connected position, when a load acts on the base portion 31 (e.g. from the second subassembly A2 on the base portion 31), the base portion 31 can be displaced relative to the second base body 20 and, for example, is displaced relative to the second base body 20 under the effect of this load, as shown in FIG. 3, without loading the second base body 20. By providing the bridge portion 34 on the transmission part 3, it is thus achieved that a load on the grip tab 30 or the base portion 31 does not directly lead to a load on the second base body 20 and thus on the connection between the first and second connecting parts 1 and 2. Only when the play made possible by the bridge portion 34 is exhausted is a force introduced into the base body 20 of the second connecting part 2 via the bridge portion 34, which is now under tension on one side. Accordingly, corresponding forces only act on the locking device V after the play made possible by the bridge portion 34 has been overcome.

Only when the grip tab 30 and thus the base portion 31 have bridged a play specified by the bridge portion 34 is the second base body 20 of the second connecting part 2 acted upon by further pulling on the grip tab 30. In this case, the second base body 20 is still loaded into an engagement position with the first base body 10 via the attracting effect of the first and second magnetic devices M1 and M2 with a magnetic force acting in a connection direction R. Against this magnetic force, the second base body 20 is then disengaged from the first base body 10 of the first connecting part 1 by further pulling on the grip tab 30 by lifting a rear end.

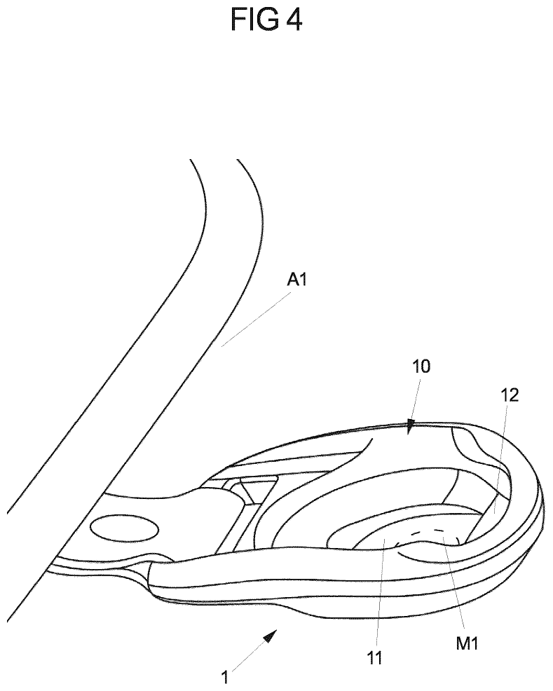

The first connecting part 1 is shown in enlarged scale in FIG. 4. The first connecting part 1 with its base body 10 has an engagement device 11 with, in this case, two opposing engagement protrusions 12. When the second connecting part 2 is attached to the first connecting part 1, a front region of the engagement portion 21 of the second base body 20 is brought into positive engagement with these engagement protrusions 12—supported by the two magnetic devices M1 and M2—so that the two connecting parts 1 and 2 are held together in the connected position then assumed and remain connected even when a load is applied to one or both of the connecting parts 1 and 2. Only by the defined displacement movement of the second base body 20 relative to the first base body 10 of the first connecting part 1, as explained above, can the two base bodies 10 and 20 be disengaged again and the connecting parts 1 and 2 be released from each other.

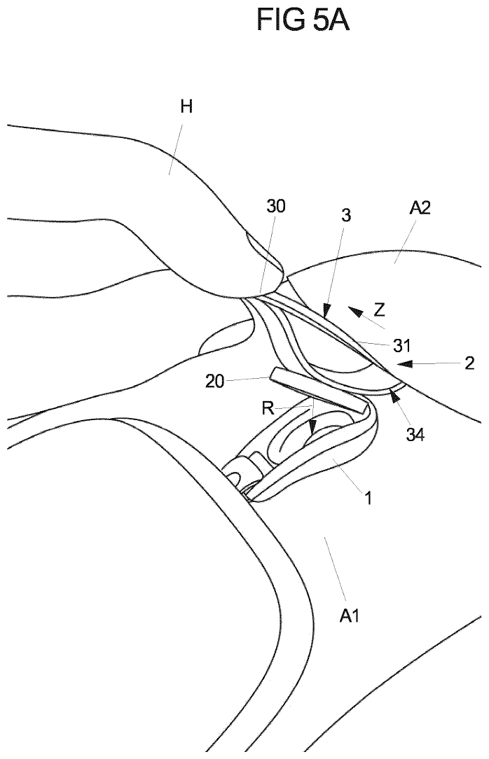

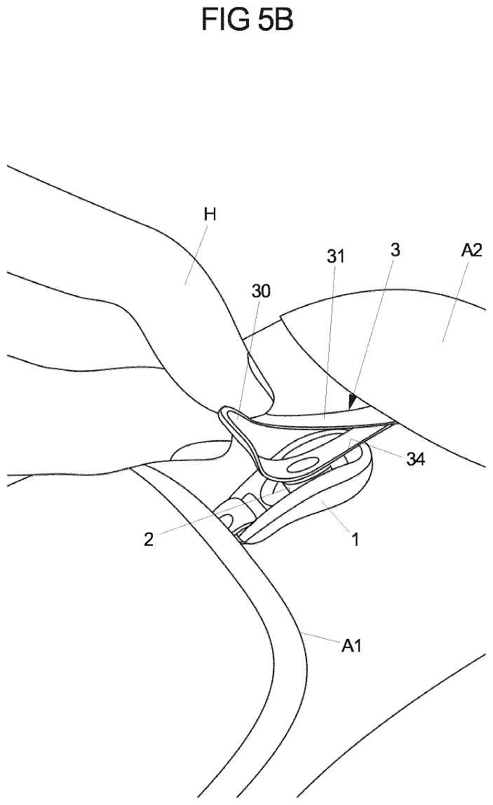

The provision of the second base body 2 on the bridge portion 34 of the transmission part 3 also facilitates the connection of the two connecting parts 1 and 2, as shown in FIGS. 5A and 5B. The bridge portion 34 thus ensures that the second base body 20 can also be brought into engagement with the first base body 10 smoothly and automatically, even if the handle tab 30 has to be pulled with a comparatively high tensile force in order to close the flap on the backpack T, for example because the backpack T might be bursting at the seams. If, for example, a user pulls on the grip tab 30 with a hand H along a tensile direction Z in order to attach the second connecting part 2 to the first connecting part 1, the base body 20 can easily snap automatically into the first base body 10 of the first connecting part 1 under the action of the magnetic device M1 and M2, since the second base body 30 provided on the bridge portion 34 can be displaced in a transverse direction (transverse to the tensile direction Z) relative to the tightly tensioned base portion 31 by the amount of play defined by the length of the flexible bridge portion 34.

As shown in FIG. 5B, the two base bodies 10 and 20 can thus be brought into engagement with each other and the two connecting parts 1 and 2 can thus be held together if a tensile force still has to be applied to the grip tab 30 in order to bring the second connecting part 2 closer to the first connecting part 1 in the first place.

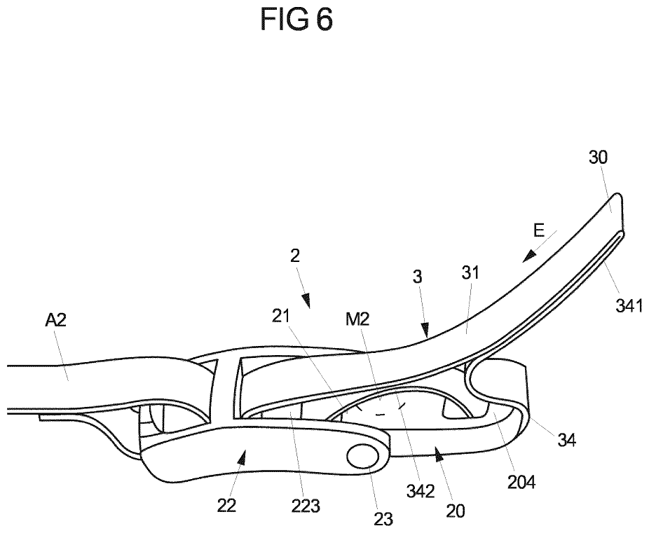

In non-limiting embodiments of a connecting device V according to FIGS. 6 to 10, a second base body 20 of a second connecting part 2 is also held on a flexible bridge portion 34 in order to introduce a play between the second base body 20 and a handling portion in the form of a grip tab 30. In deviation from the non-limiting embodiment of FIGS. 1 to 5B, the second connecting part 2 is configured in two parts and has a coupling element 22, to which the second base body 20 is articulated via a pivot axis 23. On the other hand, the second base body 20 is not fixed directly to the bridge portion 34. Rather, the flexible bridge portion 34 engages around a connecting web 204 of the second base body 30. Thus, the band-shaped, flexible bridge portion 34 is guided here through an opening in the base body 20 and engages around the end-side connecting web 204 of the second base body 20 between two end points 341 and 342 of the bridge portion 34.

The first end point 341 of the bridge portion 34 is also provided in the non-limiting embodiment of FIGS. 6 to 10 in the region of the grip tab 30 on the base portion 31, so that a force from the grip portion 30 can also be introduced into the bridge portion 34 via this. The second end point 342, at which the bridge portion 34 is again connected to the flexible base portion 31 in order to form a loop fixed to the base portion 31, is spaced from the first end point 341 in the extension direction E of the base portion 31.

In the further course in the extension direction E, the base portion 31 merges into an end loop, via which the base portion 31 embraces a connecting web 223 on the coupling element 22 and is held thereon. The coupling element 22 in turn serves to connect the second connecting part 2 to a second subassembly A2, which is configured here in the manner of a webbing strap.

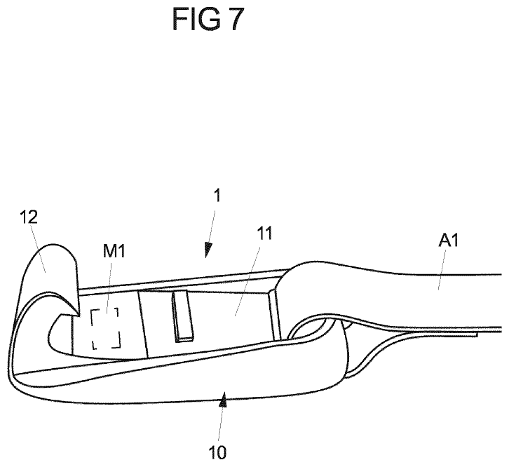

Due to the pivotability of the second base body 20 relative to the coupling element 22 of the second connecting part 2, the second connecting part can be brought into engagement with a first base body 10 of a first connecting part 1 of the connecting device V, which is shown in single view in FIG. 7. The first base body 10 of this first connecting part 1 is fixed to a first subassembly A1, which is also configured in the present case in the manner of a webbing strap. Accordingly, the two connecting parts 1 and 2 can interact in the manner of a belt buckle in order to connect two belt ends together.

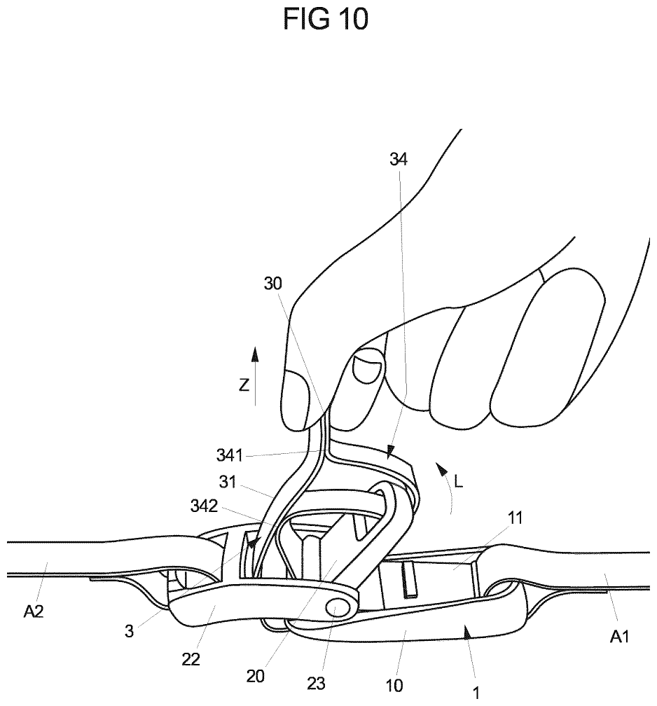

An engagement device 11 with an engagement protrusion 11 is provided on the first base body 10 of the first connecting part 1. An engagement portion 21 of the second base body 20, which is formed at a longitudinal end of the second base body 20 and faces the coupling element 22, can be brought into engagement with this single engagement protrusion 12 of the first base body 10. Thus, an engagement gap is provided between the longitudinal end of the second base body 20 and the coupling element 22, into which the engagement protrusion 12 can engage when the second connecting part 2 is placed against the first base body 10 of the first connecting part 1 as intended. First and second magnetic devices M1 and M2 of the two base bodies 10, 20 magnetically support the adoption of the connected position of the first and second connecting parts 1 and 2, in which the engagement portion 21 is engaged over by the engagement protrusion 12. In the connected position, it is only possible to release the second connecting part 2 from the first connecting part 1 against the magnetic forces applied by the first and second magnetic devices M1 and M2 by performing a tilting movement of the second base body 20 about the pivot axis 23 relative to the first base body 10. This release process is illustrated in more detail in FIG. 10.

If a user pulls on the grip tab 30 with a hand H along a tensile direction Z and pivots the second base body 20 about the pivot axis 23 along a pivot direction L as shown in FIG. 10, the two connecting parts 1 and 2 can be released from each other. By holding the base body 20 on the flexible bridge portion 34, a tensile force introduced at the grip tab 30 is again only transmitted to the connecting web 204 and thus to the base body 20 after a defined play has been bridged. Consequently, a displacement movement of the grip portion 30 by a defined amount must first have taken place before a force is introduced into the second base body 20.

Similarly, in the non-limiting embodiment of the connecting device V according to FIGS. 6 to 10 with the bridge portion 34 and the connection of the second base body 2 thereto, it is also achieved that in the connected position of the first and second connecting parts 1, 2, the base portion 31 can be displaced towards the second base body 20 in the event of a load acting on the base portion 31 (e.g. from the second subassembly A2 on the base portion 31). A load acting on the base portion 31 when the connecting device V is closed thus does not lead directly to a force being introduced into the second base body 20 and thus to a direct load on the connection between the first and second connecting parts 1, 2. In the non-limiting embodiment shown, a load also always acts on the connection of the first and second locking parts 1, 2 in the connected position due to the configure of the transfer part 3 with the bridge portion 34 and the connection of the transfer part 3 to the elements of the second connecting part 2 and thus the locking provided via this. In particular, the handling portion in the form of the grip tab 30 remains unloaded by the bridge portion 34.

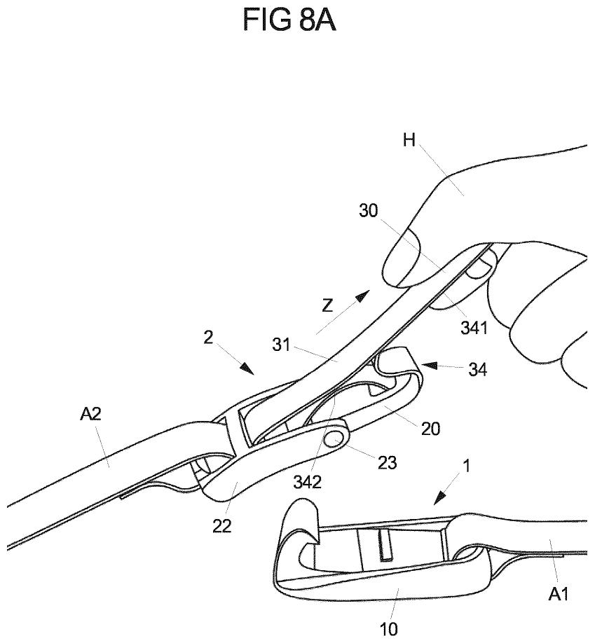

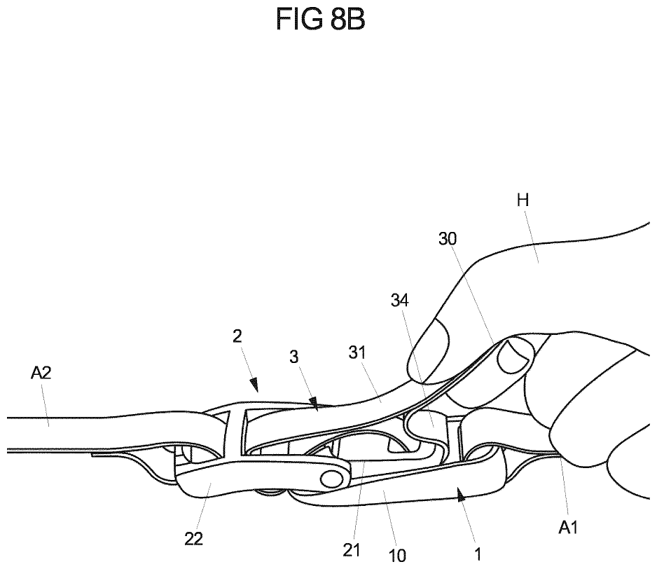

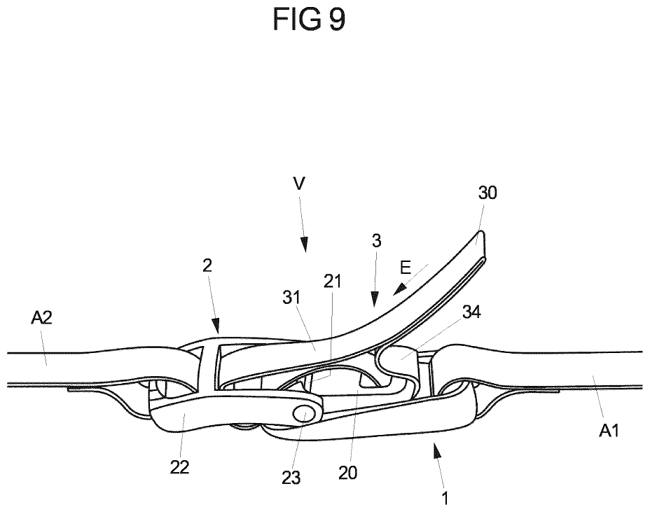

Closing of the connecting device V is illustrated in more detail in FIGS. 8A and 8B. When the second connecting part 2 is attached to the first connecting part 1 as required for this in order to connect the two subassemblies A1 and A2 via the connecting device V and hold them together, the bridge portion 34 again allows the second base body 20 to snap onto the first base body 10 by a displacement movement of the second base body 20 relative to the base portion 31 and the grip tab 30, which may be taut. FIG. 9 then shows the connected position of the first and second locking parts 1 and 2.

1. A connecting device, comprising
a first connecting part associated with a first subassembly, which comprises a first base body and an engagement device with at least one engagement protrusion, and
a second connecting part which is associated with a second subassembly, can be attached to the first connecting part and comprises a second base body with at least one engagement portion arranged on the second base body, wherein the at least one engagement portion can be brought into engagement with the engagement device of the first connecting part, so that the first connecting part and the second connecting part are held against one another in a connected position,
wherein the first connecting part comprises a first magnetic device and the second connecting part comprises a second magnetic device, wherein the first magnetic device and the second magnetic device cooperate in a magnetically attracting manner to support the attachment of the first connecting part and the second connecting part to each other,
wherein the second connecting part is connected to a handling portion and the second connecting part can be attached to the first connecting part via the handling portion and, in the connected position, a force can be applied to the handling portion in order to disengage the engagement portion from the engagement device and to release the second connecting part from the first connecting part, wherein
in order to disengage the second connecting part from the first connecting part and transmit a force to the second connecting part to disengage the engagement portion from the engagement device,
a transmission part is provided, which comprises the handling portion, a base portion connected to the handling portion and extending along an extending direction, and a bridge portion connected to the base portion at a first end point,
the bridge portion extends between the first end point and a second end point spaced from the first end point in the extension direction with a length which is greater than a distance between the two end points, and
the second base body is held on the bridge portion and the bridge portion with the second base body can be displaced relative to the base portion and the handling portion when the second connecting part is attached to the first connecting part.

2. The connection device according to claim 1, wherein a defined play of the second base body with respect to the handling portion is predetermined via the bridge portion.

3. The connect device according to claim 1, wherein a rotatability of the second base body with respect to the handling portion is limited via the bridge portion.

4. The connecting device according to claim 1, wherein a tensile force introduced at the handling portion and acting along a tensile direction can be transmitted via the base portion for attaching the second connecting part to the first connecting part, and the bridge portion can be displaced relative to the base portion along a connecting direction which is inclined with respect to the tensile direction in order to bring the engagement portion into engagement with the engagement device.

5. The connecting device according to claim 1, wherein the base portion an be displaced to the second base body via the bridge portion in the connected position and when a load acts on the base portion.

6. The connecting device according to claim 1, wherein the bridge portion consists of a flexible material or is elastically displaceable.

7. The connecting device according to claim 1, wherein the bridge portion is constructed in multiple members from at least one of fixed elements and flexible elements, and can be displaced relative to one another by adjusting the elements.

8. The connecting device according to claim 1, wherein the second base body is fixed to the bridge portion.

9. The connecting device according to claim 6, wherein the second base body is fixed to the bridge portion, wherein the second base body is sewn to the flexible material of the bridge portion.

10. The connecting device according to claim 6, wherein the second base body comprises a connection portion which is at least partially embraced by the bridge portion which at least one of consists of a flexible material and is constructed in multiple members.

11. The connecting device according to claim 1, wherein the second end point of the bridge portion is provided at the base portion or a component connected to the base portion.

12. The connecting device according to claim 1, wherein, in the connected position of the first and second locking parts, the second base body can be tilted with respect to the first base body in order to disengage the engagement portion from the engagement device.

13. The connecting device according to claim 12, wherein the second base body can be lifted off the first base body for tilting relative to the first base body on a side facing away from the at least one engagement protrusion.

14. The connecting device according to claim 1, wherein the engagement portion is rigidly arranged on the second base body.

15. The connecting device according to claim 1, wherein the at least one engagement portion of the second connecting part is formed by an edge portion which can be brought into engagement with the at least one engagement protrusion.

16. The connecting device according to claim 1, wherein the at least one engagement portion of the second connecting part extends circumferentially around the second base body.

17. The connecting device according to claim 1, wherein the at least one first engagement protrusion of the first connecting part is rigidly formed on the first base body.

18. The connecting device according to claim 1, wherein least one of the first connecting part and the second connecting part is formed in several parts.

19. A system, comprising a first subassembly and a second subassembly as well as a connecting device according claim 1, wherein the base portion is connected to the second subassembly or is at least partially or completely formed by a portion of the second subassembly.

20. (canceled)

21. (canceled)

22. The connecting device according to claim 1, wherein the connecting device is configured to connect a first subassembly and a second subassembly of a bag or a backpack.
